(19) United States
(12) Patent Application Publication
(10) Pub. No.: US 2022/0405235 A1
(43) Pub. Date: Dec. 22, 2022

(54) SYSTEM AND METHOD FOR REFERENCE DATASET MANAGEMENT

(71) Applicant: QoreNext Pte Ltd, Singapore (SG)

(72) Inventors: Rahul Sahgal, Singapore (SG); Ray Yashwant Nath, Issaquah, WA (US)

(73) Assignee: QoreNext Pte Ltd

(21) Appl. No.: 17/353,886

(22) Filed: Jun. 22, 2021

(51) Int. Cl. G06F 16/11; G06N 20/00; G06F 16/23

(52) U.S. Cl. CPC G06F 16/11; G06N 20/00; G06F 16/2365; G06Q 10/10

(57) ABSTRACT

A system for reference dataset management in a computing environment is disclosed. The plurality of subsystems includes a collection subsystem, configured to obtain reference datasets associated with one or more data domain from one or more external data sources. The plurality of subsystems also includes an analysis subsystem, configured to process the obtained reference datasets using one or more artificial intelligence-based methods and also configured to perform one or more automated tasks for the processed reference datasets using one or more prestored rules. The plurality of subsystems includes an authenticating subsystem, configured to validate quality of the processed reference datasets based on a data governance framework. The plurality of subsystems also includes a presentation subsystem, configured to publish the validated reference datasets to one or more access points using one or more application programming interfaces.

### FIELD OF INVENTION

Embodiments of the present disclosure relates to the field of data management, and more particularly to a system and a method for reference dataset management.

### BACKGROUND

An enterprise during regular interaction with customers captures various forms of data. Such data forms a critical asset for such an enterprise. Examples of these types of data are zip codes, country codes, telephone area codes, bank swift codes, disease codes, and the like. The data here consists of coded information that allows databases to make sense of the data and to process the data efficiently.

Conventionally, the stated data is very difficult to maintain. Applications and data sources often have different data models and means for tracking and reporting customer interactions, leaving enterprises with islands of difficult-to-reconcile relationship data. Furthermore, the coded information changes both randomly and periodically.

Known systems lack the process of checking and cross-checking the data and associated data codes that is captured for the above-stated maintenance problem. The stated system usually uses significant time and effort in accessing, managing, and incorporating the changing codes into their databases. Such codes are interconnected and have a one-to-one or a one-to-many relationship with each other. A more efficient approach would be to capture the data in real time from various sources and then effectively monitor and establish in real time the changing or newly developed data associated relationship codes.

Hence, there is a need for an improved system for reference dataset management and a method to operate the same and therefore address the aforementioned issues.

### BRIEF DESCRIPTION

In accordance with one embodiment of the disclosure, a system for reference dataset management in a computing environment is disclosed. The system includes a hardware processor. The system also includes a memory coupled to the hardware processor. The memory comprises a set of program instructions in the form of a plurality of subsystems. The plurality of subsystems is configured to be executed by the hardware processor.

The plurality of subsystems includes a collection subsystem. The collection subsystem is configured to obtain reference datasets associated with one or more data domain from one or more external data sources. The plurality of subsystems also includes an analysis subsystem. The analysis subsystem is configured to process the obtained reference datasets using one or more artificial intelligence-based methods. The analysis subsystem is also configured to perform one or more automated tasks for the processed reference datasets using one or more prestored rules.

The plurality of subsystems includes an authenticating subsystem. The authenticating subsystem is configured to validate the quality of the processed reference datasets based on a data governance framework. The plurality of subsystems also includes a presentation subsystem. The presentation subsystem is configured to publish the validated reference datasets to one or more access points using one or more application programming interfaces.

In accordance with one embodiment of the disclosure, a method for managing of reference dataset in a computing environment is disclosed. The method includes obtaining reference datasets associated with one or more data domain from one or more external data sources. The method also includes processing the obtained reference datasets using one or more artificial intelligence-based methods. The method also includes performing one or more automated tasks for the processed reference datasets using one or more prestored rules.

The method also includes validating the quality of the processed reference datasets based on a data governance framework. The method also includes publishing the validated reference datasets to one or more access points using one or more application programming interfaces.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram illustrating an exemplary computing system for reference dataset management in accordance with an embodiment of the present disclosure;

FIG. 2 is a block diagram illustrating another exemplary computing system for reference dataset management in accordance with an embodiment of the present disclosure;

FIGS. 3A-3C are schematic representations illustrating dashboard and related application services corresponding to the computing system for reference dataset management in accordance with an embodiment of the present disclosure;

FIGS. 4A-4E are schematic representations illustrating data governance framework structures for reference dataset management in accordance with an embodiment of the present disclosure;

FIGS. 5A-5C are schematic representations illustrating output structures regarding data governance framework in accordance with an embodiment of the present disclosure;

FIG. 6 is a block diagram illustrating components in the computing system, such as those shown in FIG. 1, in accordance with an embodiment of the present disclosure; and

FIG. 7 is a process flowchart illustrating an exemplary method for managing of the reference dataset in a computing environment in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

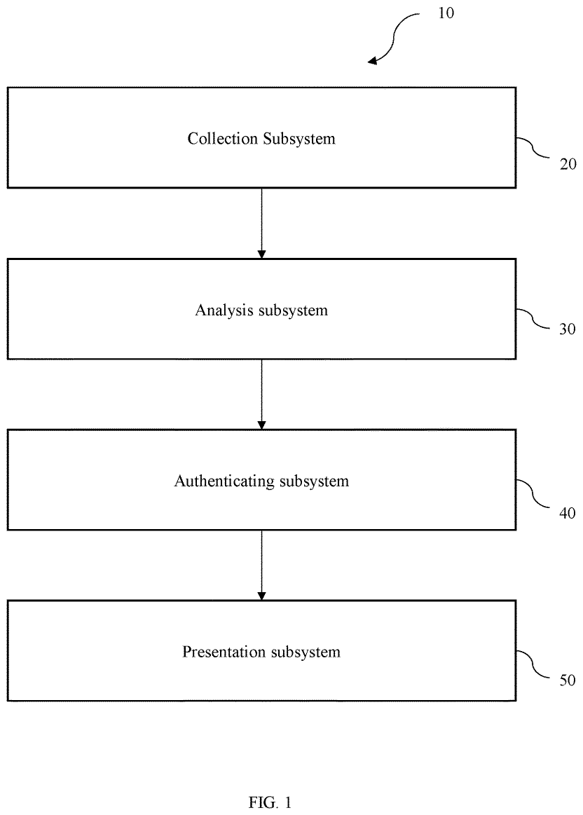

FIG. 1 is a block diagram illustrating an exemplary computing system 10 for reference dataset management in accordance with an embodiment of the present disclosure. The reference dataset is a critical part of any organization's asset. Such data is used to execute one or more tasks or gain insight into such one or more tasks for review.

First, the system 10 identifies the source of data and curates them from various publicly available sources. Then a specialized ETL (Extract, Transform and Load) program brings this identified and collected data in-house. The system 10 makes a couple of key enhancements. The relationships new codes have with existing ones are established and stored. Such storing process ensures a repository that has complete referential integrity.

The computing system 10 includes a hardware processor. The computing system 10 also includes a memory coupled to the hardware processor. The memory comprises a set of program instructions in the form of a plurality of subsystems. The plurality of subsystems is configured to be executed by the hardware processor.

The plurality of subsystems includes a collection subsystem 20. The collection subsystem 20 is configured to obtain reference datasets associated with one or more data domain from one or more external data sources. In one embodiment, the one or more external data sources include website, social media, industry data, partner data and government data. In such embodiment, each of the reference datasets comprises data set parameters. In another such embodiment, the one or more data domain signifies different types of data format. Examples of these types of data include zip codes, country codes, telephone area codes, bank swift codes, disease codes and the like.

Continuing with FIG. 1, the collection subsystem 20 is configured to identify the one or more external data sources, whereby the collection subsystem 20 configures specialize methods to obtain the reference datasets. This function is performed by artificial intelligence/machine learning (AI/ML) driven validations that check the source data on several parameters including, but not limited to, Data Format, Special Character Checks, Completeness, Data Size, Counts, etc. Any exceptions found triggers a row-level manual check or BOT enabled auto-correction depending on the selected risk tolerance level.

The collection subsystem 20 also collects location information of the obtained reference datasets. For example, the system 10 collects link details or source details of different websites. In such embodiment, the obtained reference datasets may be in the form of structured, semi structured and un-structured format. Additionally, links or connections between different one or more data domains are also identified.

In such embodiment, the machine learning technique is used as a feedback into the collection process for continuous improvement in quality of automated data collection. Further, algorithms proprietary run libraries are used for advanced mathematical operations in merging information from various sources.

The plurality of subsystems includes an analysis subsystem 30. The analysis subsystem 30 is configured to process the obtained reference datasets using one or more AI-based methods. These AI methods include, but are not limited to a process where once the initial data validation is passed through subsystem 20, it now has to integrate with other reference data sets in the Library. This is achieved through a primary-foreign key mapping across different data sets. In addition, the data sets coming from subsystem 20 is transformed to a data model that complies with a standard enterprise model. All of these transformations are AI enabled. In one embodiment, the processing of the obtained reference datasets includes gathering of the collected data and consolidating such collected data in a central storage place. In another embodiment, the processing method also considers the details regarding frequency or number times data is extracted. The consolidating process also includes a download process which downloads the data from various sources.

The analysis subsystem 30 is also configured to perform one or more automated tasks for the processed reference datasets using one or more prestored rules. In one embodiment, the one or more automated tasks include steps to perform a task in any application's graphical user interface (GUI). For example, the analysis subsystem 30 watches user perform a task in the application's graphical user interface (GUI) and then perform the automation by repeating those tasks directly in the GUI. The analysis subsystem 30 is also configured to identify patterns and producing data relationship decisions with minimal human intervention. The system 10 further measures the data quality of a data set by assigning the data a data quality score. The exceptions created in subsystem 20 measure the DQ of the Source Data. For example if 10 out of 100 rows are rejected and sent for manual/BOT mitigation, the Source DQ is 90%. All exceptions generated in subsystem 30 are DQ score of the data set. For example if 15 of the 100 rows cannot be mapped through primary/foreign key the DQ for data set is 85% and the remainder 15% will have to be manually mitigated. In such embodiment, the data analysis is automated by analytical model building. The term “analytical model building” is a branch of artificial intelligence where systems may learn from data, identify patterns and make decisions with minimal human intervention.

In such embodiment, the one or more prestored rules refers to specific requirement that is required in each one or more automated tasks. For example, loading and extracting of data is done from the one or more pages of websites based on pre-stated requirements. In another exemplary embodiment, scoring procedure of the data quality of the reference dataset is done based on the one or more prestored rules. In another embodiment, once the one or more automated tasks are done, the output is published in licenced data resources, SaaS platforms and into various application programming interface.

The plurality of subsystems also includes authenticating subsystem 40. The authenticating subsystem 40 is configured to validate quality of the reference datasets based on a data governance framework. The data governance framework comprises format, origin, relationship, usage, and management parameters. In such embodiment, format guideline ensures data entry across the enterprise which is standardized. The origin parameter understands and authenticates the data origin points and source of truth to define the data flow & ensure that the data entity. The relationship parameter defines data relation and chart a dependency map to understand the impact of one data entity to another with level of significance. The usage parameter define how the data will be used and managed within an enterprise. This is done with data access controls and configuration plan definition

The management parameter is the base of the complete framework & describes the process of developing data architecture, extraction, policies & procedures with availability of information when required. The data governance framework FORUM provides a strong data governance framework that tackles problems of global scale such as the unprecedented growth of unstructured data, the rise of information and compliance mandates. The data security method of the present disclosure enables organizations to implement security and governance policies with sustained operations and eliminates information silos that are created by integration of different data sets.

The data governance framework is configured to create standardized formats of the reference dataset, create control of data entry, create defined taxonomy guidelines and real time updates of information and industry best practices.

Furthermore, the authenticating subsystem 40 authenticates the referential dataset origin points and source of truth to define the data flow.

In such embodiment, the data relation chart is created as a dependency map to understand the data impact as a whole. Data usage method within an enterprise is tracked for further understanding.

In the data governance framework, the system 10 searches an authentic source for data. A government source is considered authentic. If the data is not available on authentic source, the system 10 searches for second reliable source. In case of postal code dataset -UPU.INT can be referenced. In case of the postal code dataset, the postal codes count are matched with the postal code count list. Further, the system 10 prepares information file (containing source URL, root source URL) for the respective dataset. As the data is obtained, all reliable details corresponding to the data is stored in an information file. The reliable details referred here includes details regarding source URL, root source URL, and the like. There could be other sources besides Government source that can considered authentic. It depend on what kind of data source being searched for.

The system 10 further downloads the raw file extracted from the source (authentic or second reliable) and formats the obtained data according to the format table of the respective datasets. The system 10 further cleans the data using excel commands Lastly, the system 10 prepares the final formatted file. In such exemplary embodiment, a quality check is performed for any damage detection. The complete framework describes the process of developing data architecture, extraction, policies and procedures with all available information.

The plurality of subsystem also includes a presentation subsystem 50. A presentation subsystem 50 is configured to publish the validated reference datasets to one or more access points using one or more application programming interfaces. The one or more access points may be any form of computing interface. In an embodiment, the presentation subsystem 50 publishes the validated reference datasets into a library. The library is an archive of data sets, which can be used to maintain subscriptions to licensed data resources for its users to access the information. Further, the presentation subsystem 50 publishes the validated reference datasets into no-code SaaS Data Model Push, which is an integration with other SaaS platforms such as ERP/CRM (Salesforce®, Dynamics®, and the like). Further, the presentation subsystem 50 publishes the validated reference datasets into the application programming interface, which is a set of programming code that enables data transmission between one software product and another.

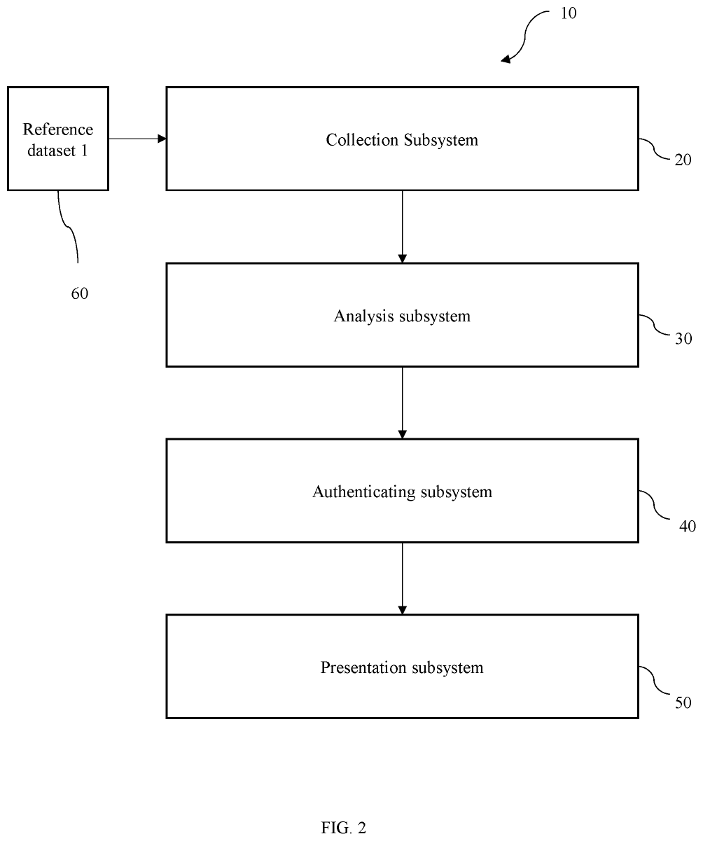

FIG. 2 is a block diagram illustrating another exemplary computing system 10 for reference dataset management in accordance with an embodiment of the present disclosure. In one exemplary embodiment, the reference dataset 1 60 corresponds to a postal address. The system 10 first identifies the source of the postal address data and curates the data by the collection subsystem 20. The referential datasets corresponding to the postal data is stored in a database for execution. The obtained reference datasets are processed using one or more artificial intelligence-based methods by the analysis subsystem 30. The analysis subsystem 30 validates the quality of reference datasets via a data governance framework. The data governance framework identifies what is changed from any known existing reference datasets. In case of the postal code dataset, the system 10 matches the postal codes count with the postal code count list. The system 10 may also check the data description of the postal codes.

An authenticating subsystem 40 checks for the meta-data (FORUM). Subsystem 40 defines the “gold standard” of the data—where should it come from, what should be size, what is the refresh rate, who is managing it, what is the definition of it, etc. The other subsystems reference this system and make sure everything complies to this gold standard. In such exemplary embodiment, the hierarchy tree is cross checked. Starting and trailing places are also checked for authentication. Specially, the count values of the reference datasets are matched with prestored values and checked for duplicate values. Further, the hierarchy tree of the reference dataset is checked. Further, the values of the reference dataset are checked randomly from the data file by searching on a web. In case of postal codes check the values of the regions and postal code by randomly checking the values on web. Further, the starting and trailing spaces in the reference datasets is checked. Further, data description of the postal codes is checked. Finally, the values of ISO Codes from web are matched with the postal codes of the reference datasets.

In validating the quality of the processed reference datasets based on the data governance framework, the authentication subsystem 40 is configured to determine if there are any errors in the validated reference datasets; and automatically rectify the determined errors in the validated reference datasets by replacing correct values in the reference datasets.

In an embodiment, the system 10 includes matching services to determine if results received from various sources are different for the same data component. Further, manual check on cases where a discrepancy is found, with feedback through machine learning can be performed. The system 10 may use algorithms to highlight major changes in the reference dataset compared to previous publish and any logical anomalies. For continuous learning of quality of the reference dataset, machine learning may be used.

The presentation subsystem 50 is configured to publish the validated reference datasets to one or more access points using one or more application programming interfaces. The one or more access points may be any form of computing interface. For any error, excel commands are used for checking. The presentation subsystem 50 uploads a final formatted attribute file into the computing system 10 and stored the file. Further, the presentation subsystem 50 publishes the attributes. Further, the presentation subsystem 50 uploads the relationship file (if any) in to computing system 10 and publishes the relationships.

Further, the presentation subsystem 50 downloads the published data from the computing system 10. Also, the presentation subsystem 50 check for any errors using excel commands. In case of any errors, the presentation subsystem 50 rectifies the incorrect values and replaces with the correct values. Further, the presentation subsystem 50 does a final check and reports any issues.

The presentation subsystem 50 is further configured to maintain and manage the reference datasets by periodically updating the reference datasets based on the frequency of data extraction required, modifying the data quality based on data quality score, and adding related parameters to the reference datasets. For updating the reference datasets periodically, the presentation subsystem 50 schedules dates for data refresh, based on the frequency of data extraction required. For modifying the data quality and improving the data quality, the presentation subsystem 50 modifies and improves the data quality based on its data quality score and specification.

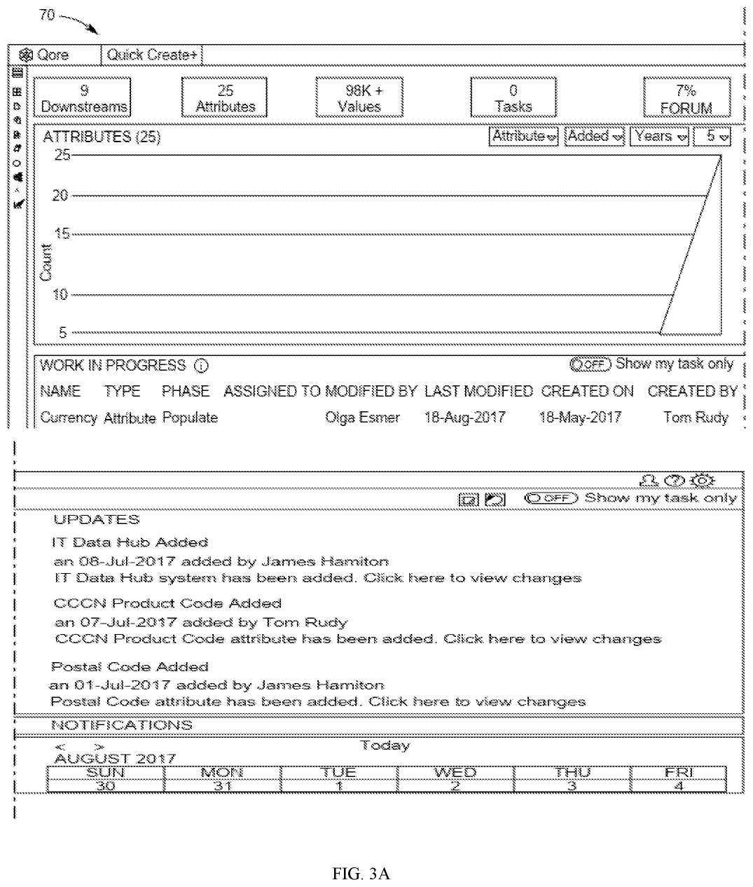

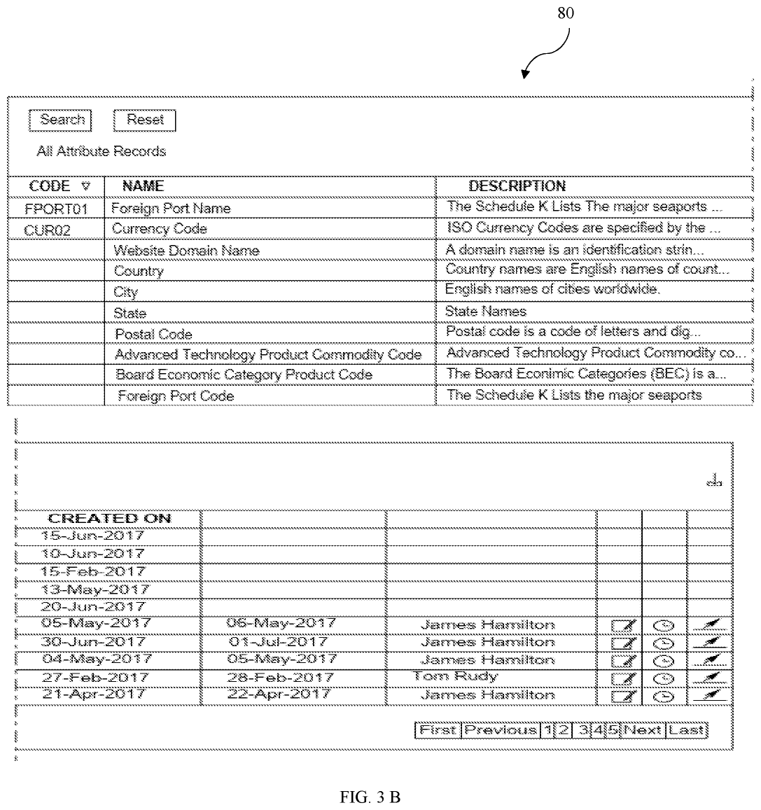

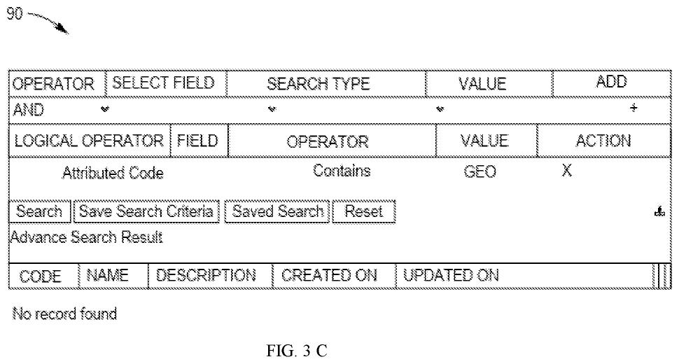

FIGS. 3A-3C are schematic representation illustrating dashboard and related application services corresponding to the computing system 10 for reference dataset management in accordance with an embodiment of the present disclosure. FIG. 3A provides an intuitive and interactive centralized reference and meta data dashboard view 70. A user may experience real time tracking for reference and meta data updates and status update on service request progress. In such an embodiment, tracking is done using a blockchain paradigm which allows easy review of past state at any given point in time. And finally, the data is made business ready via Machine-Learning-driven Robotic Process Automation. This allows a degree of quality that has not been seen in the market until now. The dashboard view may provide real time information like count and rate of change of reference datasets. FIG. 3B provides a search result view 80. The dashboard search result includes attribute name, description, synonym, associated system, and the like. Meanwhile, FIG. 3C provides explore attribute view 90. The dashboard view provides ability to customize query search which may be ideal for data stewards auditing data.

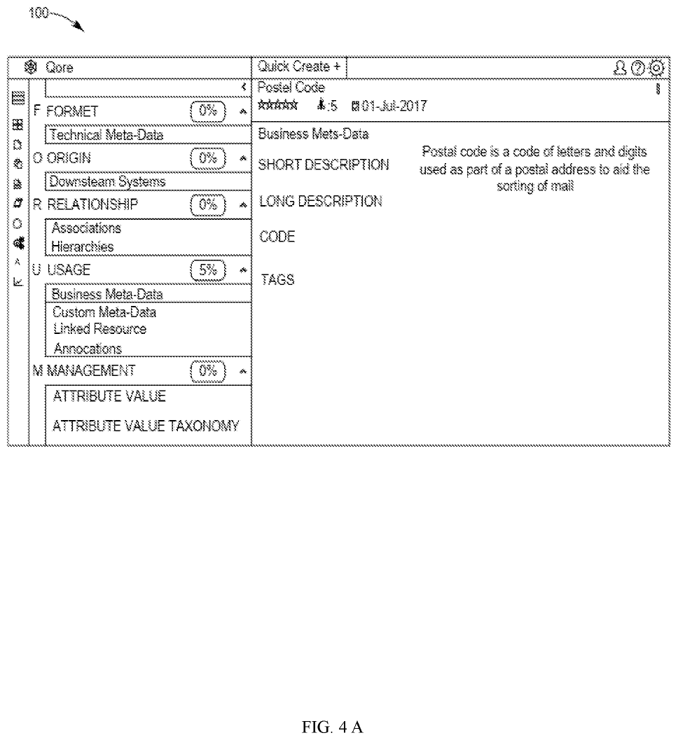

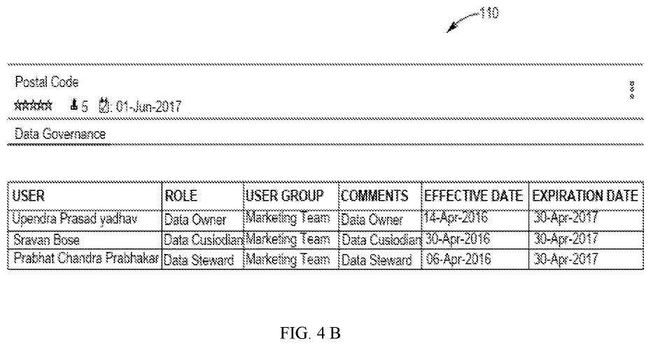

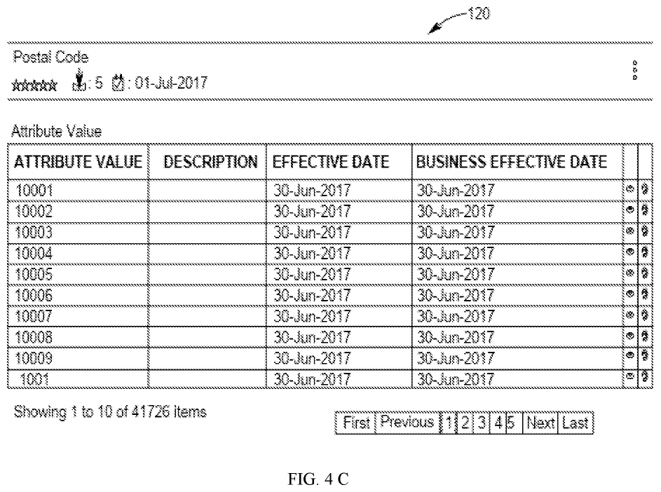

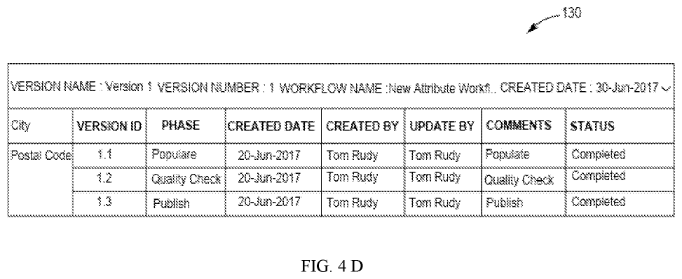

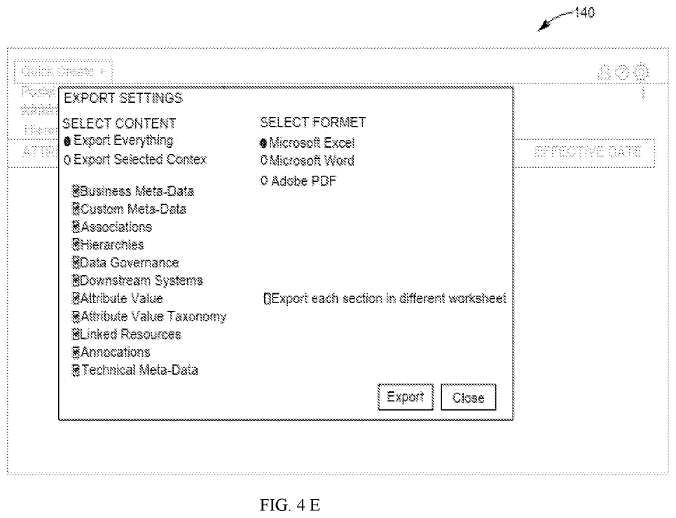

FIGS. 4A-4E are schematic representations illustrating data governance framework structure for reference datasets management in accordance with an embodiment of the present disclosure. The governance framework structure enables structuring the data by subject area, data facet, entities for better control, reporting and management. The governance framework structure has ability to enforce change management by subject area or entities for simplified data governance. The format details that are provided are data type, data length, drop down list, free text field and the like. Such details enforce data governance by tracking the source of truth and data origin within the enterprise.

FIG. 4A provides details regarding how the data is used in the systems using the standard fields and custom fields 100. The system 10 provides ability to capture the definition of attributes or define how it will be used using the standard fields and custom fields. Such ability enables the standardized implementation therefore reducing data quality issues. The system 10 further gives ability to attach additional references, URLs, and help documents for providing additional information for informed usage and implementation. Such view presentation provide visibility to any upcoming change specific to the attribute or reference data.

FIG. 4B represents key details of the exemplary stakeholders 110. Such presentation enables the system 10 to keep track of key stakeholders, contact people such as data owners, data stewards for enforcing data governance and better change control management. The presentation enables the workflow management by engaging all the approvers before a change is processed.

FIG. 4C provide details about dataset reference value 120. The presentation enables the business to forecast the reference data changes for future, allowing flexibility to assess the impact before the values are implemented in the system.

FIG. 4D provides details about dataset version history 130. Version history includes meta data and reference data changes for all major and minor releases. Version capability includes storing of subversions until an attribute is finally published within the enterprise. In such embodiment, subversions are created as a request for change goes through multiple phases of a workflow.

FIG. 4E discloses methodology to export the related data 140 within multiple worksheets. Multiple formats are supported for the download thereby providing flexibility for data consumption.

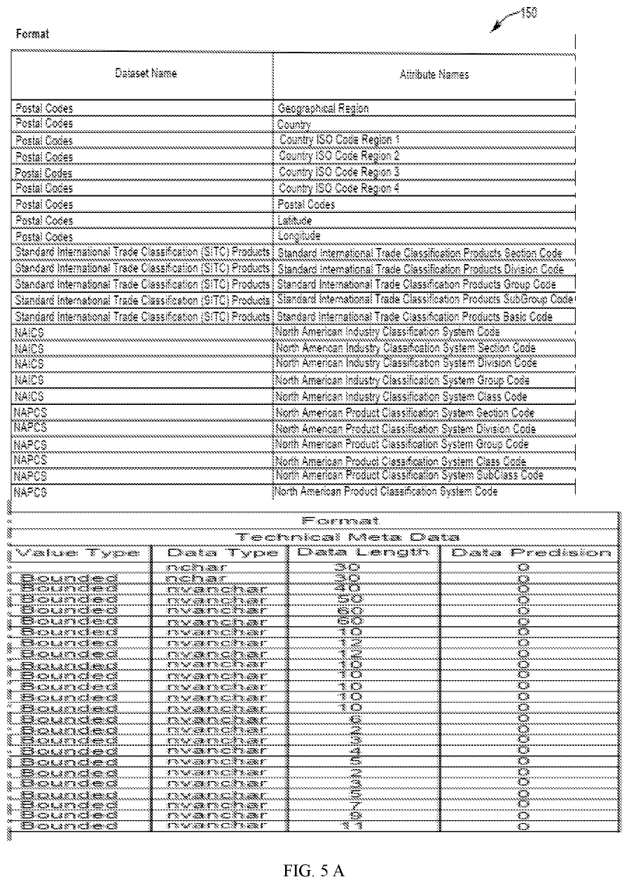

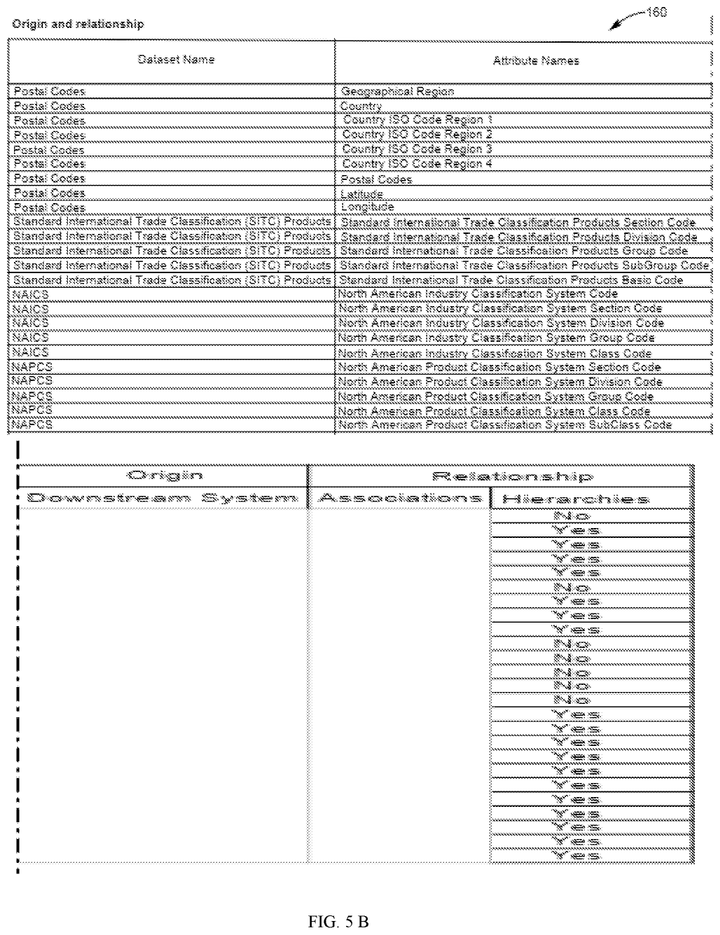

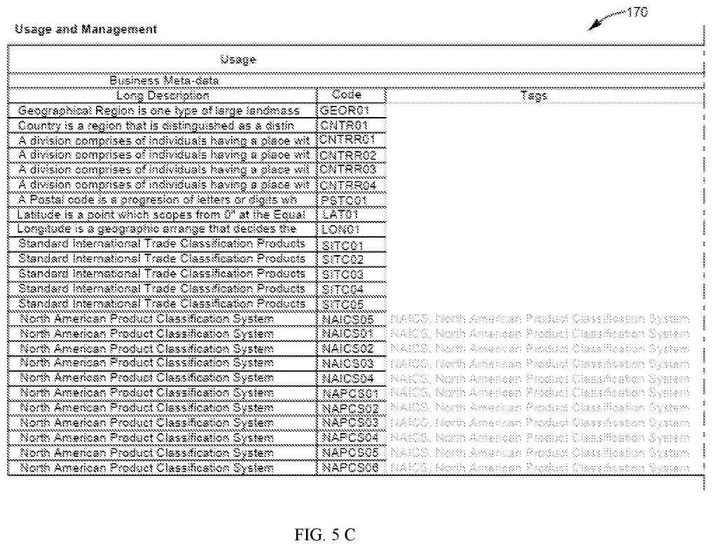

FIGS. 5A-5C are schematic representation illustrating an output structure regarding data governance framework in accordance with an embodiment of the present disclosure. FIG. 5A provides the format output 150. FIG. 5B provides the origin and relationship output 160. FIG. 5C provides the usage and management result output 170. According to some embodiments, the structure includes the following:
Format—defines the expected length of the data, data type (int,. char., etc.), special character allowance, standard template, etc.;
Origin—what is the origin of the data. There could be multiple origins;
Relationship—which other data sources can these be mapped to;
Usage—what is the technical and business use of this data, who should use it, and under what conditions and assumptions; and
Management—individuals/BOTS responsible to managing the data set.

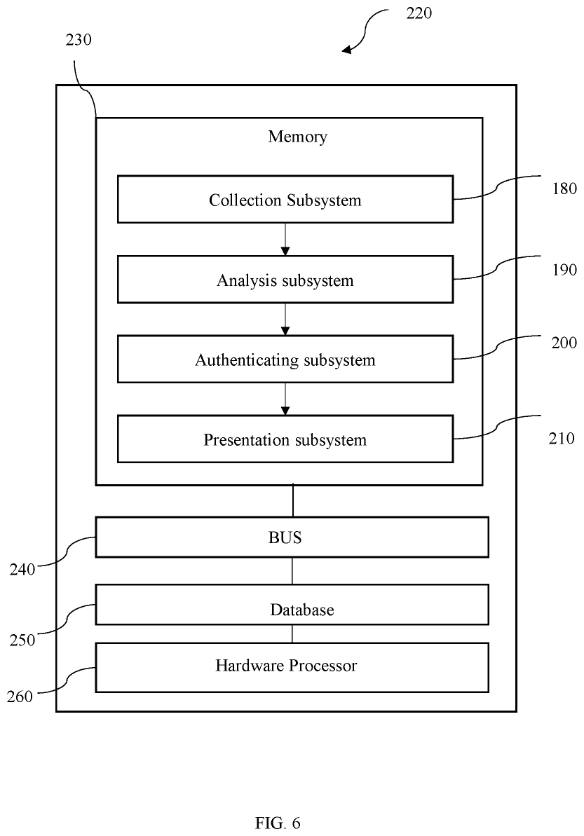

FIG. 6 is a block diagram illustrating components in the computing system 220, such as those shown in FIG. 1, in accordance with an embodiment of the present disclosure. The components in the computing system 220 includes a memory 230, the hardware processor 260, a bus 240 and a database 250.

The processor(s) 260, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 230 includes a plurality of subsystems stored in the form of executable program which instructs the hardware processor 260 via bus 240 to perform the method steps illustrated in FIG. 1. The database 250 is configured to store collected reference datasets. The memory has following subsystems: a collection subsystem 180, an analysis subsystem 190, an authenticating subsystem 200 and a presentation subsystem 210.

The collection subsystem 180 is configured to obtain reference datasets associated with one or more data domain from one or more external data sources. The analysis subsystem 190 is configured to process the obtained reference datasets using one or more artificial intelligence-based methods. The analysis subsystem 190 is also configured to perform one or more automated tasks for the processed reference datasets using one or more prestored rules.

The authenticating subsystem 200 is configured to validate quality of the processed reference datasets based on a data governance framework. The presentation subsystem 210 is configured to publish the validated reference datasets to one or more access points using one or more application programming interfaces.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 260.

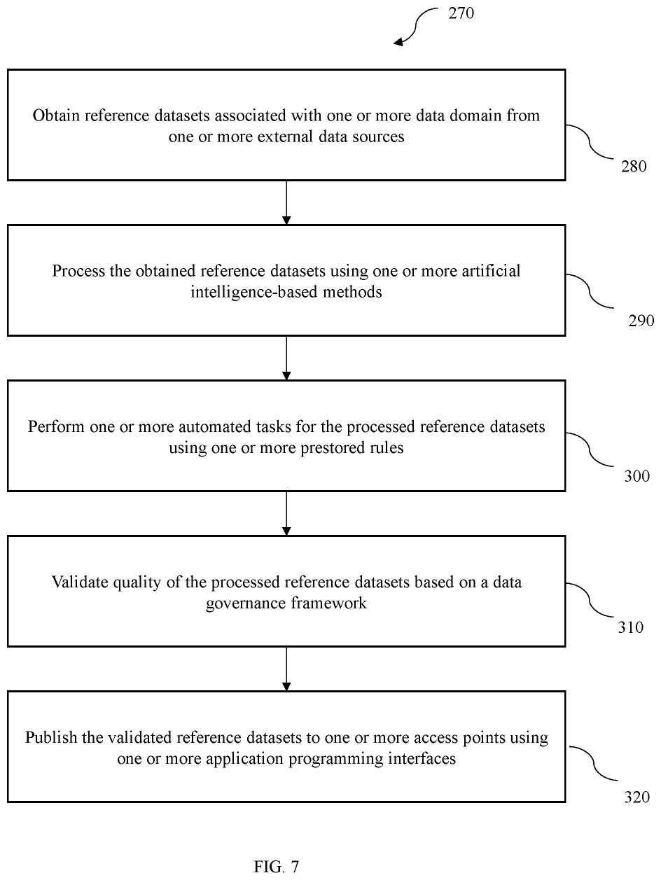

FIG. 7 is a process flowchart 270 illustrating an exemplary method for managing of reference dataset in a computing environment in accordance with an embodiment of the present disclosure. At step 280, reference datasets are obtained associated with one or more data domain from one or more external data sources. In one aspect of the present embodiment, reference datasets are obtained associated with one or more data domain by a collection subsystem.

In one embodiment, each of the reference datasets comprises data set parameters. In such embodiment, obtaining the dataset parameters comprises obtaining details representative of data source, data location, data type and data attributes and links.

At step 290, the obtained reference datasets are processed using one or more artificial intelligence-based methods. In one aspect of the present embodiment, the obtained reference datasets are processed using the one or more artificial intelligence-based methods by an analysis subsystem. In another aspect of the present embodiment, processing using the one or more artificial intelligence-based methods comprises of method of extraction, transformation, and loading of the reference datasets from the one or more external data sources with extraction frequency plan.

At step 300, one or more automated tasks for the processed reference datasets is performed using one or more prestored rules. In one aspect of the present embodiment, the one or more automated tasks for the processed reference datasets is performed by the analysis subsystem. In another aspect of the present embodiment, performing the one or more automated tasks comprises performance of task representative of loading and extracting of the data from one or more pages of websites, performing task execution in the application's graphical user interface (GUI), identifying patterns and producing data relationship decisions with minimal human intervention, measuring the data quality of the data set, assigning a data quality score and publishing the related data.

At step 310, quality of the processed reference datasets is validated based on a data governance framework. In one aspect of the present embodiment, quality of the processed reference datasets is validated by an authenticating subsystem. In such embodiment, the data governance framework comprises format, origin, relationship, usage, and management parameters.

At step 320, the validated reference datasets are published to one or more access points using one or more application programming interfaces. In one aspect of the present embodiment, the validated reference datasets are published by a presentation subsystem.

Additionally, the method also includes periodic updating of the obtained reference datasets using one or more machine learning methods.

Various embodiments of the present disclosure are enabled to meet the growing demand for reliable and easily consumed reference datasets which is simply not available at scale across verticals today. The use of governance framework structure reduces a great deal of time and effort that is used by enterprises in accessing, managing and incorporating changing codes into their respective databases.

The disclosed system is a cloud-based platform focused on foundational data or reference dataset and its impact on making Artificial intelligence and business intelligence initiatives successful. The system provides reliable data with highest quality and integrity on a real time basis at unprecedented quality and accuracy, i.e., 20% higher than currently available.

A user may purchase the system after meta data review as available for users. One time purchase or subscription model purchase is also possible. For secure usage, the user may login via specific email id.

The disclosed system provides hundreds of reference data attributes available on the public exchange library. Easy navigation and search options like name, synonym, industry and the like are available. The disclosed system provides easy ability to access all meta data and download feature for sample reference data.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for reference dataset management in a computing environment, the system comprising:
a hardware processor; and
a memory coupled to the hardware processor, wherein the memory comprises a set of program instructions in the form of a plurality of subsystems, configured to be executed by the hardware processor, wherein the plurality of subsystems comprises:
a collection subsystem configured to obtain reference datasets associated with one or more data domain from one or more external data sources, wherein each of the reference datasets comprises dataset parameters;
an analysis subsystem configured to:
process the obtained reference datasets using one or more artificial intelligence-based methods; and
perform one or more automated tasks for the processed reference datasets using one or more prestored rules;
an authenticating subsystem configured to validate quality of the processed reference datasets based on a data governance framework, wherein the data governance framework comprises format, origin, relationship, usage, and management parameters; and
a presentation subsystem configured to publish the validated reference datasets to one or more access points using one or more application programming interfaces.

2. The system of claim 1, wherein data set parameters comprises details representative of data source, data location, data type and data attributes and links.

3. The system of claim 1, wherein the one or more automated tasks for the processed reference datasets comprises performing the one or more automated task representative of loading and extracting of data from one or more pages of websites, performing task execution in the application's graphical user interface (GUI), identifying patterns and producing data relationship decisions with minimal human intervention, measuring the data quality of the data set, assigning a data quality score and publishing the related data.

4. The system of claim 1, wherein the one or more artificial intelligence-based methods for processing comprises the method of extraction, transformation, and loading of the reference datasets from the one or more external data sources with extraction frequency plan.

5. The system of claim 1, wherein in validate quality of the processed reference datasets based on a data governance framework, the authentication subsystem is configured to determine if there are any errors in the validated reference datasets; and automatically rectify the determined errors in the validated reference datasets by replacing correct values in the reference datasets.

6. The system of claim 1, wherein the presentation subsystem is further configured to maintain and manage the reference datasets by periodically updating the reference datasets based on the frequency of data extraction required, modifying the data quality based on data quality score, and adding related parameters to the reference datasets.

7. The system of claim 1, wherein the data governance framework is configured to create standardized formats of the reference dataset, create control of data entry, create defined taxonomy guidelines and real time updates of information and industry best practices.

8. A method for managing of reference dataset in a computing environment, the method comprising:
obtaining, by a processor, reference datasets associated with one or more data domain from one or more external data sources, wherein each of the reference datasets comprises data set parameters;
processing, by the processor, the obtained reference datasets using one or more artificial intelligence-based methods;
performing, by the processor, one or more automated tasks for the processed reference datasets using one or more prestored rules;
validating, by the processor, quality of the processed reference datasets based on a data governance framework, wherein the data governance framework comprises format, origin, relationship, usage, and management parameters; and
publishing, by the processor, the validated reference datasets to one or more access points using one or more application programming interfaces.

9. The method of claim 5, further comprises periodically updating the obtained reference datasets using one or more machine learning methods.

10. The method of claim 5, wherein obtaining the data set parameters comprises obtaining details representative of data source, data location, data type and data attributes and links.

11. The method of claim 5, wherein performing the one or more automated tasks comprises performing task representative of loading and extracting of the data from one or more pages of websites, performing task execution in the application's graphical user interface (GUI), identifying patterns and producing data relationship decisions with minimal human intervention, measuring the data quality of the data set, assigning a data quality score and publishing the related data.

12. The method of claim 5, wherein processing the obtained reference datasets using the one or more artificial intelligence-based methods comprises: extracting, transforming, and loading of the reference datasets from the one or more external data sources with extraction frequency plan.

13. The method of claim 5, wherein validating the quality of the processed reference datasets based on the data governance framework comprises determining if there are any errors in the validated reference datasets; and automatically rectifying the determined errors in the validated reference datasets by replacing correct values in the reference datasets.

14. The method of claim 5, wherein the method further comprises: maintaining and managing the reference datasets by periodically updating the reference datasets based on the frequency of data extraction required, modifying the data quality based on data quality score, and adding related parameters to the reference datasets.

15. The method of claim 5, wherein the data governance framework is configured to create standardized formats of the reference dataset, create control of data entry, create defined taxonomy guidelines and real time updates of information and industry best practices.

16. A non-transitory computer-readable storage medium having instructions stored therein that, when executed by a hardware processor, cause the processor to perform method steps comprising:
obtaining reference datasets associated with one or more data domain from one or more external data sources, wherein each of the reference datasets comprises data set parameters;
processing the obtained reference datasets using one or more artificial intelligence-based methods;
performing one or more automated tasks for the processed reference datasets using one or more prestored rules;
validating a quality of the processed reference datasets based on a data governance framework, wherein the data governance framework comprises format, origin, relationship, usage, and management parameters; and
publishing the validated reference datasets to one or more access points using one or more application programming interfaces.

17. The non-transitory computer-readable storage medium of claim 16, further comprises periodically updating the obtained reference datasets using one or more machine learning methods.

18. The non-transitory computer-readable storage medium of claim 16, wherein obtaining the data set parameters comprises obtaining details representative of data source, data location, data type and data attributes and links.

19. The non-transitory computer-readable storage medium of claim 16, wherein performing the one or more automated tasks comprises performing task representative of loading and extracting of the data from one or more pages of websites, performing task execution in the application's graphical user interface (GUI), identifying patterns and producing data relationship decisions with minimal human intervention, measuring the data quality of the data set, assigning a data quality score and publishing the related data.

20. The non-transitory computer-readable storage medium of claim 16, wherein processing the obtained reference datasets using the one or more artificial intelligence-based methods comprises extracting, transforming, and loading of the reference datasets from the one or more external data sources with extraction frequency plan.
